(19) United States
(12) Patent Application Publication
(10) Pub. No.: US 2014/0170525 A1
(43) Pub. Date: Jun. 19, 2014

(54) MEMBRANE ELECTRODE ASSEMBLY AND FUEL CELL INCLUDING THE SAME

(71) Applicant: Samsung Electronics Co., Ltd., Suwon-si (KR)

(72) Inventors: Suk-gi HONG, Seongnam-si (KR); Jin-su HA, Cheonan-si (KR); Jung-ock PARK, Yongin-si (KR); Yoon-hoi LEE, Hwaseong-si (KR)

(21) Appl. No.: 14/069,580

(22) Filed: Nov. 1, 2013

(30) Foreign Application Priority Data
Dec. 17, 2012 (KR) 10-2012-0147722

(51) Int. Cl. H01M 8/10

(52) U.S. Cl. CPC H01M 8/1004
USPC 429/482

(57) ABSTRACT

A membrane-electrode assembly and a fuel cell including a cathode; an anode; and an electrolyte membrane disposed between the cathode and the anode, wherein the anode has a specific pore volume greater than a specific pore volume of the cathode, and the anode has a specific pore volume of about 0.05 milliliters per gram to about 0.09 milliliters per gram.

### CROSS-REFERENCE TO RELATED APPLICATIONS

This application claims priority to and the benefit of Korean Patent Application No. 10-2012-0147722, filed on Dec. 17, 2012, and all the benefits accruing therefrom under 35 U.S.C. §119, the content of which is incorporated herein by reference in its entirety.

### BACKGROUND

1. Field

The present disclosure relates to a membrane-electrode assembly and a fuel cell including the membrane-electrode assembly.

A. 2. Description of the Related Art

According to a type of an electrolyte and fuel used, fuel cells can be classified as polymer electrolyte membrane fuel cells (“PEMFC”s), direct methanol fuel cells (“DMFC”s), phosphoric acid fuel cells (“PAFC”s), molten carbonate fuel cells (“MCFC”s), or solid oxide fuel cells (“SOFC”s).

In particular, PEMFCs have a wide range of applications, such as in mobile electronic devices, portable power devices, small cogeneration devices, and vehicles. In general, PEMFCs include a membrane-electrode assembly (“MEA”) including an anode, a cathode, and a polymer electrolyte membrane interposed between the anode and the cathode, and plates including fuel and air supply paths. Protons are generated by hydrogen oxidation in the anode, and then migrate to the cathode through the polymer electrolyte membrane. Water is generated through oxidation and reduction in the cathode.

However, PEMFCs have poor resistance to fuel impurities, and employ water management and heat dissipation systems. Accordingly, there is an increasing demand for systems operable at a high temperature of about 150° C. to about 160° C.

PEMFCs operable at high temperatures have high catalytic activity and strong resistance to fuel impurities, and PEMFC system operation is simplified by avoiding use of a preferential oxidation (“PROX”) reactor and a humidifier. For high-temperature operation, a polybenzimidazole electrolyte membrane impregnated with phosphoric acid may be used. In this regard, phosphoric acid may serve as a proton transfer medium between the electrolyte membrane and the anode and cathode. However, cell operation for a long time may lead to loss of the phosphoric acid from the electrolyte membrane and the electrodes, which consequently results in cell resistance increase and cell performance degradation. Therefore, there is a high demand for the development of methods of suppressing the loss of phosphoric acid.

### SUMMARY

Provided is a fuel cell with improved cell performance and improved lifetime and having an electrode with improved phosphoric acid retention ability.

Additional aspects will be set forth in part in the description which follows and, in part, will be apparent from the description.

According to an aspect, a membrane-electrode assembly includes: a cathode; an anode; and an electrolyte membrane disposed between the cathode and the anode, wherein the anode has a specific pore volume greater than a specific pore volume of the cathode, and the anode has a pore volume of about 0.05 milliliters per gram (mL/g) to about 0.09 mL/g.

The cathode may have a pore volume of about 0.03 mL/g to about 0.04 mL/g.

The anode and the cathode may each independently include a catalyst layer including a catalyst including a carbonaceous support and a catalytic metal disposed on the carbonaceous support, and the catalyst of the anode may have a larger specific surface area that of the catalyst of the cathode.

The catalyst of the anode may have a specific surface area of about 300 square meters per gram (m²/g) or greater, and in some embodiments, from about 350 m²/g to about 400 m²/g.

The catalyst of the cathode may have a specific surface area of about 200 m²/g or less, and in some embodiments, about 100 m²/g to about 150 m²/g.

The anode and the cathode may each include a catalyst layer including a catalyst including a carbonaceous support and a catalytic metal disposed on the carbonaceous support, and the carbonaceous support of the anode may have a larger specific surface area that of the carbonaceous support of the cathode.

The carbonaceous support of the anode may have a specific surface area of about 700 m²/g to about 900 m²/g, and in some embodiments, about 100 m²/g to about 300 m²/g.

The anode and the cathode may each include a catalyst layer including a catalyst including a carbonaceous support and a catalytic metal disposed on the carbonaceous support, and an amount of the catalytic metal on each catalyst layer may be about 10 parts to about 90 parts by weight, based on 100 parts by weight of a total weight of the catalytic metal and the carbonaceous support.

According to another aspect, a fuel cell includes the membrane-electrode assembly.

### BRIEF DESCRIPTION OF THE DRAWINGS

These and/or other aspects will become apparent and more readily appreciated from the following description of the embodiments, taken in conjunction with the accompanying drawings in which:

FIG. 1 is a perspective exploded view of an embodiment of a fuel cell;

FIG. 2 is a cross-sectional view of a membrane-electrode assembly (“MEA”) of the fuel cell of FIG. 1;

FIG. 3 is a graph of pore volume (milliliters per gram, mL/g) with respect to pore diameter (micrometers, μm) in anodes of fuel cells of Example 1 and Comparative Example 1; and

FIG. 4 is a graph of cell voltage (Volts, V) with respect to current density (amperes per square centimeter, A/cm²) as a result of an accelerated lifetime test of the fuel cells of Example 1 and Comparative Example 1.

### DETAILED DESCRIPTION

Reference will now be made in detail to embodiments, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. “Or” means “and/or.” Expressions such as “at least one of,” when preceding a list of elements, modify the entire list of elements and do not modify the individual elements of the list.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

According to an embodiment, a membrane-electrode assembly includes a cathode, an anode, and an electrolyte membrane disposed between the cathode and the anode, the anode having a specific pore volume greater than that of the cathode, and the anode having a specific pore volume of about 0.05 mL/g to about 0.09 mL/g.

In some embodiments, the anode may have a specific pore volume of about 0.06 mL/g to about 0.08 mL/g.

When the specific pore volume of the anode is less than about 0.05 mL/g, the anode may not have a sufficient ability to retain a phosphoric-acid based material. When the specific pore volume of the anode is greater than about 0.09 mL/g, excess phosphoric acid may be present in the anode, causing flooding.

The cathode may have a specific pore volume of about 0.03 mL/g to about 0.04 mL/g.

As is further described above, since the anode has a structure suitable for retaining a phosphoric acid-based material and has a greater pore volume than that of the cathode, a fuel cell including the anode may have improved durability.

As used herein, the term “specific pore volume” refers to a volume of pores per unit weight having a diameter of about 30 nm or less, for example, from about 0.1 nm to about 30 nm, which may be measured using a mercury pore measurement device.

The specific pore volume may vary depending on the amount of a catalytic metal, the loading amount of the catalytic metal per unit area of electrode, and the thickness of an electrode catalyst layer. For example, the pore volume may be measured with an amount of the catalytic metal of 10 to 90 parts by weight, based on 100 parts by weight of a total weight of the catalytic metal, a loading amount of the catalyst of 0.5 milligrams per square centimeter (mg/cm²) to 2.0 mg/cm², wherein loading is determined per unit area of electrode, and a thickness of the electrode catalyst layer of 30 micrometers (μm) to 70 μm.

The phosphoric acid-based material as a type of proton conductor and may comprise phosphoric acid (H₃PO₄), pyrophosphoric acid, polyphosphoric acid, methphosphoric acid, or a derivative thereof. A concentration of the phosphoric acid-based material is not specifically limited. For example, the concentration of the phosphoric acid-based material may be about 80 weight percent (wt %) to 100 wt %, specifically about 85 wt % to about 99 wt %, more specifically about 90 wt % to about 98 wt %, of the phosphoric acid aqueous solution.

The specific pore volumes of the anode and the cathode refer to the specific pore volumes of an anode catalyst layer and a cathode catalyst layer, respectively, the anode catalyst layer containing an anode catalyst including a support and an anode catalytic metal disposed on, e.g., loaded on, the support, and the cathode catalyst layer containing a cathode catalyst including a support and a cathode catalytic metal loaded on the support.

In some embodiments, the anode and the cathode may each include an anode or cathode catalyst layer including an anode or cathode catalyst including a support and a catalytic metal loaded on the support, the anode catalyst having a specific surface area selected to be larger than that of the cathode catalyst.

When the specific surface area of the anode catalyst is larger than that of the cathode catalyst, the anode may have a large pore volume relative to that of the cathode.

The anode catalyst may have a specific surface area of about 300 m²/g or greater, and in some embodiments, from about 350 m²/g to about 400 m²/g.

The cathode catalyst may have a specific surface area of about 200 m²/g or less, and in some embodiments, from about 100 m²/g to about 150 m²/g.

In some embodiments, the anode and the cathode may each independently include an anode or cathode catalyst layer including an anode or cathode catalyst including a carbonaceous support and a catalytic metal loaded on the carbonaceous support, the carbonaceous support of the anode having a larger specific surface area than that of the carbonaceous support of the cathode. When the specific surface area of the carbonaceous support in the anode is larger than that of the carbonaceous support in the cathode, the anode may have a larger pore volume than that of the cathode.

The carbonaceous support of the anode may have a specific surface area of about 700 m²/g to about 900 m²/g, specifically about 750 m²/g to about 850 m²/g and the carbonaceous support of the cathode may have a specific surface area of about 100 m²/g to about 300 m²/g, specifically about 100 m²/g to about 300 m²/g.

An amount of the catalytic metal in each of the anode catalyst layer and the cathode catalyst layer may independently be about 10 parts to about 90 parts by weight, and in some embodiments, about 20 parts to about 80 parts by weight, and in some other embodiments, about 30 parts to about 60 parts by weight, based on 100 parts by weight of a total weight of the catalytic metal and the support, i.e., a total weight of a supported catalyst, When the amount of the catalytic metal is within these ranges, the supported catalyst may have a large specific surface area that suitably retains a suitable amount of active catalytic particles. While not wanting to be bound by theory, it is understood that such properties may consequently improve utilization efficiency of the catalyst and performance of a fuel cell.

In some embodiments, the catalytic metal in each of the anode and the cathode may comprise at least one selected from platinum (Pt), iron (Fe), cobalt (Co), nickel (Ni), ruthenium (Ru), rhodium (Rh), palladium (Pd), osmium (Os), iridium (Ir), copper (Cu), silver (Ag), gold (Au), tin (Sn), titanium (Ti), chromium (Cr), and an alloy comprising at least one thereof.

In some embodiments, e.g., to prevent or reduce an increase in an electric resistance of a fuel cell, the anode catalyst layer may have a thickness of about 10 μm to about 100 μm, and the cathode catalyst layer may have a thickness of about 10 μm to about 100 μm.

A loading amount of the catalytic metal in the anode may be about 0.5 mg/cm² to about 2.0 mg/cm². A loading amount of the catalytic metal in the cathode may be from about 0.5 mg/cm² to about 2.0 mg/cm². When the loading amounts of the catalytic metals in the anode and the cathodes are within these ranges, the catalysts may have high utilization efficiencies and performance of a fuel cell may be improved.

The carbonaceous support of each of the anode catalyst layer and the cathode catalyst layer may independently comprise at least one selected from carbon powder, carbon black, acetylene black, ketjen black, active carbon, carbon nanotubes, carbon nanofibers, carbon nanowires, carbon nanohorns, carbon aerogels, carbon cryogels, and carbon nanorings.

In some embodiments, the catalytic metal in each of the anode and the cathode may independently have an average particle diameter of about 1 nm to about 20 nm, and in some embodiments, about 2 nm to about 10 nm. When the average particle diameters of the catalytic metals are within these ranges, the catalysts may have high activities and electrochemically sufficient specific surface areas.

For example, the catalytic metal of each of the anode and the cathode may comprise at least one selected from platinum (Pt), iron (Fe), cobalt (Co), nickel (Ni), ruthenium (Ru), rhodium (Rh), palladium (Pd), osmium (Os), iridium (Ir), copper (Cu), silver (Ag), gold (Au), tin (Sn), titanium (Ti), chromium (Cr), and an alloy of at least one thereof.

For example, the catalyst of the cathode catalyst layer may comprise a supported catalyst including PtCo loaded on a carbonaceous support. For example, the catalyst of the anode catalyst layer may comprise a supported catalyst including PtRu loaded on a carbonaceous support.

The cathode catalyst layer and the anode catalyst layer may each include a binder.

For example, the binder may comprise at least one proton-conducting polymer selected from a fluorine-based polymer, a benzimidazole-based polymer, a polyimide-based polymer, a polyether imide-based polymer, a polyphenylene sulfide-based polymer, a polysulfone-based polymer, a polyether sulfone-based polymer, a polyether ketone-based polymer, a polyether-ether ketone-based polymer, and a polyphenylquinoxaline polymer.

For example, the binder may comprise at least one selected from polyvinylidenefluoride (“PVdF”), polytetrafluoroethylene (“PTFE”), vinylidene fluoride-hexafluoropropylene copolymer, and fluorine-terminated phenoxide based hyperbranched polymer (“HPEF”).

An amount of the binder in each catalyst layer may be about 1 part to about 30 parts by weight, based on 100 parts by weight of the catalyst. When the amount of the binder is within this range, the catalyst may have a high utilization efficiency to improve performance of a fuel cell.

According to another embodiment, a fuel cell includes the membrane-electrolyte assembly (MEA) disclosed herein.

In some embodiments, the fuel cell may be a polymer electrolyte membrane fuel cell (“PEMFC”) or a phosphoric acid fuel cell (“PAFC”).

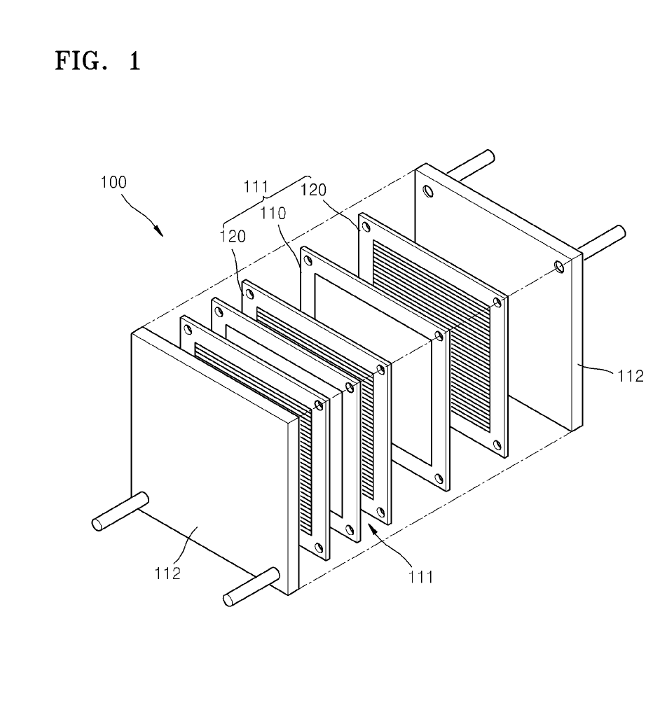

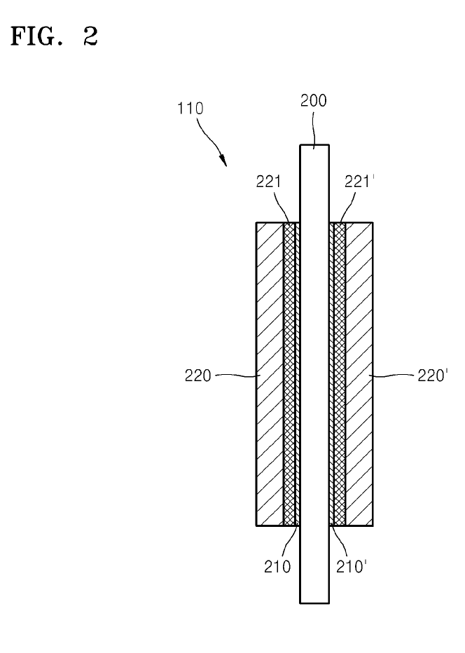

FIG. 1 is a perspective exploded view of a fuel cell 100 according to an embodiment. FIG. 2 is a cross-sectional view of a MEA of the fuel cell 100 of FIG. 1.

Referring to FIG. 1, the fuel cell 100 includes two unit cells 111 which are supported by a pair of holders 112. Each unit cell 111 includes an MEA 110, and bipolar plates 120 disposed on opposite sides of the MEA 110. Each bipolar plate 120 includes a conductive metal, carbon or the like, and serves as a current collector by being bound to the MEA 110, and also supplies oxygen and fuel to catalyst layers of the MEA 110.

Although the fuel cell 100 of FIG. 1 includes two unit cells 111, the number of the unit cells 111 is not limited, and may be up to several tens to hundreds, e.g., 1 to about 1000 unit cells, according to the characteristics desired for the fuel cell 1.

Referring to FIG. 2, each MEA 110 includes an electrolyte membrane 200, and a cathode and an anode respectively disposed on opposite surfaces of the electrolyte membrane 200 in the thickness direction thereof. The cathode and the anode respectively include first and second catalyst layers 210 and 210′, first and second primary gas diffusion layers 221 and 221′ respectively disposed on the catalyst layers 210 and 210′, and first and second secondary gas diffusion layers 220 and 200′ respectively disposed on the primary gas diffusion layers 221 and 221′.

The secondary gas diffusion layers 220 and 220′ diffuse oxygen and fuel supplied through the bipolar plates 120 over the entire surfaces of the catalyst layers 210 and 210′, respectively, and transfer electrons generated in one of the catalyst layers 210 and 210′ that serves as an anode catalyst layer, to the other catalyst layer.

The catalyst layers 210 and 210′ may each include a cathode or an anode, and a binder.

The first gas diffusion layers 221 and 221′ may include carbon black and polytetrafluoroethylene. The second gas diffusion layers 220 and 220′ may include carbon paper, carbon cloth, carbon pelt, or the like.

The electrolyte membrane 200 is not particularly limited, and may comprise at least one selected from polybenzimidazole (“PBI”), cross-linked polybenzimidazole, poly(2,5-benzimidazole) (“ABPBI”), polyurethane, modified polytetrafluoroethylene (“PTFE”), and a polymer of bezoxazine-based monomers.

The electrolyte membrane 200 may be impregnated with a phosphoric acid-based material.

The fuel cell 100 including the MEA 110 may operate at a temperature of 40° C. to 200° C. Fuel such as hydrogen is supplied through one of the bipolar plates 120 into a first catalyst layer, and an oxidant such as oxygen is supplied through the other bipolar plate 120 into a second catalyst layer. Then, hydrogen is oxidized into protons (H⁺) in the first catalyst layer, and the protons are conducted to the second catalyst layer through the electrolyte membrane 200. Then, the protons electrochemically react with oxygen in the second catalyst layer to produce water (H₂O).

An embodiment will now be described in more detail with reference to the following examples. However, these examples are for illustrative purposes only and are not intended to limit the scope of the one or more embodiments.

### EXAMPLES

### Example 1

1.0 gram (g) of a supported catalyst (PtCo/C, 30 wt % of PtCo), 0.02 g of polyvinylidenefluoride, and 5.0 g of N-methyl-2-pyrrolidone were mixed together, and then stirred at room temperature for about 30 minutes to obtain a cathode catalyst layer composition.

The cathode catalyst layer composition was coated on carbon paper with a wire bar, and then dried at about 80° C. for about 1 hour, at about 120° C. for about 30 minutes, and then at about 150° C. for about 10 minutes to form a cathode catalyst layer of a cathode. The cathode catalyst layer had a thickness of about 50 μm.

The carbon support of the cathode had a specific surface area of about 200 m²/g, and the supported catalyst (PtCo/C) had a specific surface area of about 145 m²/g. A loading amount of Pt in the cathode was about 0.8 mg/cm².

1.0 g of a supported catalyst (PtRu/C, 30 wt % of PtRu), 0.02 g of polyvinylidenefluoride, and 5.0 g of N-methyl-2-pyrrolidone were mixed together, and stirred at room temperature for about 30 minutes to obtain an anode catalyst layer composition.

The anode catalyst layer composition was coated on carbon paper with a wire bar, and then dried at about 80° C. for about 1 hour, at about 120° C. for about 30 minutes, and then at about 150° C. for about 10 minutes to form an anode catalyst layer of an anode. The anode catalyst layer had a thickness of about 50 μm.

The carbon support of the anode had a specific surface area of about 800 m²/g, and the supported catalyst (PtRu/C) had a specific surface area of about 370 m²/g. A loading amount of Pt in the anode was about 0.6 mg/cm².

A benzoxazine-based polymer membrane impregnated with a 85 wt % phosphoric acid aqueous solution was used as an electrolyte membrane disposed between the cathode and the anode.

The benzoxazine-based polymer membrane was manufactured by blending about 70 parts by weight of polybenzimidazole (“PBI”) of Formula 1 below and about 30 part by weight of a compound (“HF-A”) of Formula 2 below and curing the mixture at a temperature of about 80° C. to about 250° C.

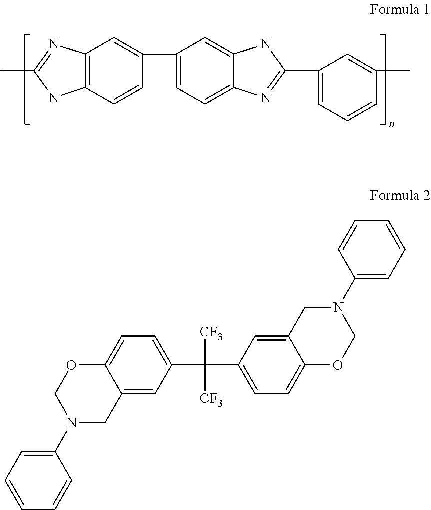

In Formula 1, n is from 10 to 500.

Subsequently, the resultant was impregnated with 85 wt % of phosphoric acid at about 80° C. for 4 hours or longer to obtain the electrolyte membrane. An amount of the phosphoric acid was about 80 parts by weight, based on 100 parts by weight of the electrolyte membrane.

The electrolyte membrane was disposed between the cathode and the anode to manufacture a membrane-electrode assembly (“MEA”).

### Comparative Example 1

1.0 g of a supported catalyst (PtCo/C, 30 wt % of PtCo), 0.02 g of polyvinylidenefluoride, and 5.0 g of N-methyl-2-pyrrolidone were mixed together, and then stirred at room temperature for about 30 minutes to obtain a cathode catalyst layer composition.

The cathode catalyst layer composition was coated on carbon paper with a wire bar, and then dried at about 80° C. for about 1 hour, at about 120° C. for about 30 minutes, and then at about 150° C. for about 10 minutes to form a cathode catalyst layer of a cathode. The cathode catalyst layer had a thickness of about 50 μm.

The carbon support of the cathode had a specific surface area of about 200 m²/g, and the supported catalyst (PtCo/C) had a specific surface area of about 145 m²/g. A loading amount of Pt in the cathode was about 0.8 mg/cm².

1.0 g of a supported catalyst (PtRu/C, 30 wt % of PtRu), 0.02 g of polyvinylidenefluoride, and 5.0 g of N-methyl-2-pyrrolidone were mixed together, and stirred at room temperature for about 30 minutes to obtain an anode catalyst layer composition.

The anode catalyst layer composition was coated on carbon paper with a wire bar, and then dried at about 80° C. for about 1 hour, at about 120° C. for about 30 minutes, and then at about 150° C. for about 10 minutes to form an anode catalyst layer of an anode. The anode catalyst layer had a thickness of about 50 μm.

The carbon support of the anode had a specific surface area of about 200 m²/g, and the supported catalyst (PtRu/C) had a specific surface area of about 130 m²/g. A loading amount of Pt in the anode was about 0.6 mg/cm².

A benzoxazine-based polymer membrane impregnated with a 85 wt % phosphoric acid aqueous solution as used in Example 1 was disposed between the cathode and the anode as an electrolyte membrane, thereby manufacturing a MEA.

### Evaluation Example 1

### Evaluation of Pore Volume of Electrode and Specific Surface Areas of Catalyst and Support

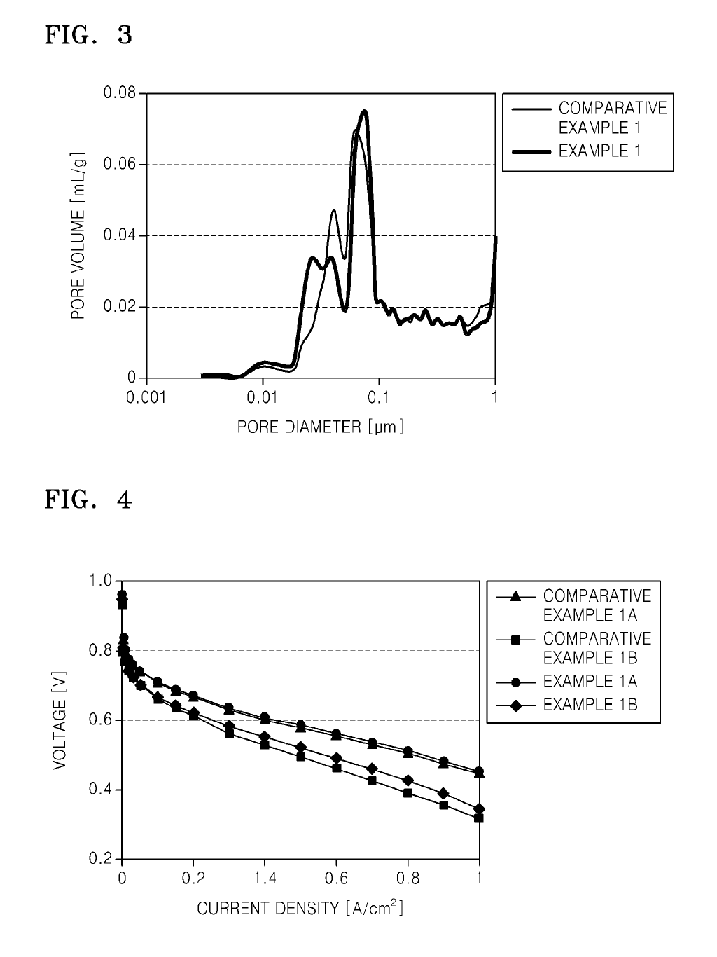

Pore volumes of the anodes and cathodes of Example 1 and Comparative example 1 with respect to pore diameter were measured. The results are shown in FIG. 3. The volumes of pores having a diameter of about 30 nm or less in the anodes and cathodes are shown in Table 1 below, along with the specific surface areas of the supported catalysts and the specific surface areas of the carbon supports used in Example 1 and Comparative Example 1.

The pore volume was determined using a mercury pore measurement device.

TABLE 1

| | Anode | | | Cathode | | |
|---|---|---|---|---|---|---|
| | Specific Pore | Specific surface | Specific surface | Specific Pore | Specific surface | Specific surface |
| | volume of | area of supported | area of | volume of | area of supported | area of |
| Example | electrode (mL/g) | catalyst [m²/g] | support [m²/g] | electrode (mL/g) | catalyst [m²/g] | support [m²/g] |
| Example 1 | 0.07 | 370 | 800 | 0.034 | 145 | 200 |
| Comparative | 0.038 | 130 | 200 | 0.034 | 145 | 200 |
| Example 1 | | | | | | |

### Evaluation Example 2

### Accelerated Lifetime Evaluation

Accelerated lifetimes of unit cells including the MEAs of Example 1 and Comparative Example 1, respectively, were evaluated. The results are shown in Table 2 below.

The accelerated lifetime test was performed while repeating a cycle of 30 seconds at 0.6V and 30 seconds at 0.9V. Cell performance degradation with respect to number of cycles were evaluated to estimate accelerated lifetime of each cell. Each cycle in the accelerated lifetime evaluation corresponds to a lifetime of 1 hour.

In the accelerated lifetime test, the number of cycles at which an operating voltage of the cell dropped to about 0.6V or less at a current density of about 0.2 A/cm² was represented as accelerated lifetime.

TABLE 2

| Example | Accelerated lifetime (number of cycles) |
|---|---|
| Example 1 | 16,000 |
| Comparative Example 1 | 14,000 |

Referring to Table 2, the fuel cell including the MEA of Example 1 was found to have improved accelerated lifetime as compared with the fuel cell of Comparative Example 1.

### Evaluation Example 3

### Cell Performance

Cell performance was evaluated at about 150° C. while supplying hydrogen as fuel to the anode and air as an oxidant to the cathode.

Cell performance was evaluated before and after the accelerated lifetime test of the unit cells including the MEAs of Example 1 and Comparative Example 1, respectively. The results are shown in FIG. 4.

In FIG. 4, “A” indicates the results of the cell performance test before the accelerated lifetime test, and “B” indicates the results of the cell performance test after the accelerated lifetime test.

Referring to FIG. 4, the unit cell including the MEA of Example 1 before the accelerated lifetime test was found to exhibit similar performance to that of the unit cell including the MEA of Comparative Example 1. However, the unit cell including the MEA of Example 1 after the accelerated lifetime test exhibited higher performance than the performance of the unit cell including the MEA of Comparative Example 1.

As described above, according to an embodiment, a fuel cell with improved cell durability may be manufactured using an electrode with improved phosphoric acid retention ability.

It should be understood that the exemplary embodiments described therein should be considered in a descriptive sense only and not for purposes of limitation. Descriptions of features, advantages, or aspects within each embodiment shall be considered as available for other similar features, advantages, or aspects in other embodiments.

What is claimed is:

1. A membrane-electrode assembly comprising:
a cathode;
an anode; and
an electrolyte membrane disposed between the cathode and the anode, wherein the anode has a specific pore volume greater than a specific pore volume of the cathode, and
the anode has a specific pore volume of about 0.05 milliliters per gram to about 0.09 milliliters per gram.

2. The membrane-electrode assembly of claim 1, wherein the anode has a specific pore volume of about 0.06 milliliters per gram to about 0.08 milliliters per gram.

3. The membrane-electrode assembly of claim 1, wherein the cathode has a specific pore volume of about 0.03 milliliters per gram to about 0.04 milliliters per gram.

4. The membrane-electrode assembly of claim 1,
wherein the anode and the cathode each independently comprise a catalyst layer including a catalyst comprising a carbonaceous support and a catalytic metal disposed on the carbonaceous support, and
wherein the catalyst of the anode has a specific surface area which is greater than a specific surface area of the catalyst of the cathode.

5. The membrane-electrode assembly of claim 4, wherein the catalyst of the anode has a specific surface area of about 300 square meters per gram or greater.

6. The membrane-electrode assembly of claim 5, wherein the catalyst of the anode has a specific surface area of about 350 square meters per gram to about 400 square meters per gram.

7. The membrane-electrode assembly of claim 4, wherein the catalyst of the cathode has a specific surface area of about 200 square meters per gram or less.

8. The membrane-electrode assembly of claim 7, wherein the catalyst of the cathode has a specific surface area of about 100 square meters per gram to about 150 square meters per gram.

9. The membrane-electrode assembly of claim 1, wherein the anode and the cathode each independently comprise a catalyst layer including a catalyst comprising a carbonaceous support and a catalytic metal disposed on the carbonaceous support, and wherein the carbonaceous support of the anode has a larger specific surface area than a specific surface area of the carbonaceous support of the cathode.

10. The membrane-electrode assembly of claim 9, wherein the carbonaceous support of the anode has a specific surface area of about 700 square meters per gram to about 900 square meters per gram.

11. The membrane-electrode assembly of claim 9, wherein the carbonaceous support of the cathode has a specific surface area of about 100 square meters per gram to about 300 square meters per gram.

12. The membrane-electrode assembly of claim 1, wherein the anode and the cathode each independently comprise a catalyst layer including a catalyst comprising a carbonaceous support and a catalytic metal disposed on the carbonaceous support, and wherein an amount of the catalytic metal on each catalyst layer is independently about 10 parts to about 90 parts by weight, based on 100 parts by weight of a total weight of the catalytic metal and the carbonaceous support.

13. The membrane-electrode assembly of claim 1, wherein a catalytic metal of each of the anode and the cathode is independently at least one selected from platinum (Pt), iron (Fe), cobalt (Co), nickel (Ni), ruthenium (Ru), rhodium (Rh), palladium (Pd), osmium (Os), iridium (Ir), copper (Cu), silver (Ag), gold (Au), tin (Sn), titanium (Ti), chromium (Cr), and an alloy comprising at least one thereof.

14. The membrane-electrode assembly of claim 13, wherein a loading amount of the catalytic metal in the anode is from about 0.5 milligrams per square centimeter to about 2.0 milligrams per square centimeter.

15. The membrane-electrode assembly of claim 13, wherein a loading amount of the catalytic metal in the cathode is from about 0.5 milligrams per square centimeter to about 2.0 milligrams per square centimeter.

16. A fuel cell comprising the membrane-electrode assembly of claim 1.
